(19) United States
(12) Patent Application Publication
(10) Pub. No.: US 2005/0196132 A1
(43) Pub. Date: Sep. 8, 2005

(54) Video recording and reproducing apparatus and communication method thereof

(75) Inventor: Ju-Yup Lee, Seongnam-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/017,753

(22) Filed: Dec. 22, 2004

(30) Foreign Application Priority Data
Mar. 8, 2004 (KR) 2004-15582

(51) Int. Cl. H04N 5/76; H04N 5/781

(52) U.S. Cl. 386/46; 386/125

(57) ABSTRACT

A combined video reproducing system, or briefly, a combo system, incorporates therein at least three components and a suggested method sets data transmission path for the communication among the components. Among the at least three components, a main component for comprehensively controlling the combo system, and at least two sub components for performing communication with the main component, are determined. Also, for the data transmission, the respective connecting terminals of the main component are connected with the connecting terminals of the sub components. By doing so, at least two sub components can be connected with the minimum connecting terminals of the main component.

### CROSS-REFERENCE TO RELATED APPLICATIONS

This application claims the benefit under 35 U.S.C. §119(a) of Korean Patent Application No. 2004-15582, filed Mar. 8, 2004, in the Korean Intellectual Property Office, the entire disclosure of which is hereby incorporated by reference.

### BACKGROUND OF THE INVENTION

1. Field of the Invention

The present invention relates to a communication protocol for communication among the constituents of a video reproducing system. More particularly, the present invention relates to an apparatus and a method for enabling a communication among constituents of a video reproducing system without a collision.

2. Description of the Related Art

A combination system or a “combo-system”, or more briefly, a ‘combo’, incorporates more than two separate parts in a single integrated system. A DVDP/VCR combo system having a digital video disc player (DVDP) and a video cassette recorder (VCR) is one example of a combo system.

FIG. 1 schematically illustrates a DVDP/VCR combo system and peripheral devices connected thereto. The DVDP/VCR combo system 100 includes a VCR unit 110 having general VCR functions such as reproducing video and audio from a magnetic tape and recording externally-received signal onto a magnetic tape, and a DVDP unit 120 of general DVDP function such as reproducing video and audio from a digital video disc. The DVDP/VCR combo system 100 additionally provides complex features such as recording of video and audio of the DVDP unit 120 onto the magnetic tape of the VCR unit 110.

The DVDP/VCR combo system 100 is connected with peripheral devices such as a TV 150 for outputting video and audio from the DVDP unit 120 or the VCR unit 110, and an audio amp 140 for outputting audio from the DVDP unit 120. Additionally, the DVDP/VCR combo system 100 may be connected to external devices 160, such as a camcorder. The DVDP/VCR combo system 100 records and reproduces video and audio inputted from the external devices 160.

The VCR unit 110 and the DVDP unit 120 are provided in a single integrated DVDP/VCR combo system 100, and the user operates a mode switch for switching between the VCR unit 110 and the DVDP unit 120 or the individual functions of the VCR unit 110 and the DVDP unit 120 through an operating panel (not shown) provided at the front side of the DVDP/VCR combo system 100.

FIG. 2 is a block diagram of a DVDP/VCR combo system 100 as one example of a combo system.

The DVDP/VCR combo system 100 includes a VCR unit 110 of general VCR function, a DVDP unit 120 of general DVDP function, a selection unit 170 for selecting from among the signals of the VCR unit 110 and the DVDP unit 120, an input unit 185 providing signals from the external devices 160 such as camcorder to the selection unit 170, an output unit 180 for providing signals from the VCR unit 110 and the DVDP unit 120 to the peripheral devices such as a TV or an amplifier, and an on-screen display (OSD) block 175 for an OSD function to the video signals of the VCR unit 110 and the DVDP unit 120.

The VCR unit 110 includes a VCR deck 111 for recording signals onto a magnetic tape or reproducing signals from the magnetic tape, a video block 112 and audio block 113 for transmitting and receiving video and audio signals, respectively, for recording or reproducing with respect to the VCR deck 111. Additionally, the VCR unit 110 includes a VCR control unit 114 for controlling the overall operation of the VCR deck 111, the video block 112 and the audio block 113. The VCR unit 110 includes a display 116 for externally indicating the control and the mode setting to the user, an operating panel 117 for receiving operation commands from the user, and a remote control sensor 118 for receiving operation commands from the user via the remote controller 130.

The DVDP unit 120 includes a DVD deck 121, a DVD servo 122, a DVD control unit 123 and a DVD encoder 124. The DVD deck 121 reads in data from the DVD for the reproducing operation, and the DVD servo 122 performs operations with respect to the DVD deck 121 such as position control and speed control. The DVD encoder 124 receives through the DVD control unit 123 the data which is read by the DVD deck 121, and outputs DVD video data and DVD audio data. The DVD control unit 123 controls the overall operations of the DVD deck 121, the DVD servo 122 and the DVD encoder 124.

The DVDP unit 120 includes a macro-vision detection unit 126. The macro-vision detection unit 126 detects a macro-vision signal from the data of the DVD deck 121 during the reproducing or copying of DVD with macro-vision protection. The macro-vision detection unit 126 provides the detected data to the DVD control unit 123. The DVD control unit 123 transmits the detected macro-vision signal to the VCR control unit 114.

The DVD control unit 123 and the VCR control unit 114 are operated in accordance with the detected macro-vision signal and generates a control signal for the DVDP unit 120 and the VCR unit 110. This will be described in more detail below.

The selection unit 170 receives signals from the DVD encoder 124, the video block 112 and the audio block 113, and the input unit 185. The selection unit 170 selects with respect to the signals which are controlled and inputted by the VCR control unit 114 and the DVD control unit 123, and selects signals from the selection unit 170 are inputted to the OSD block 175 and the output unit 180.

The OSD block 175 operates to add an OSD function to the signals which are input from the selection unit 170. Accordingly, images for additional display on the screen such as a TV screen, for example, menu images for the control of operation of the DVDP unit 120 and the VCR unit 110, or the macro-vision error message, are constructed by the OSD block 175.

The output unit 180 receives signals from the DVD encoder 124, the selection unit 170 and the OSD block 175, and outputs signals with respect to the DVD video, DVD audio, VCR video and VCR audio. The output unit 180 is connected to peripheral devices such as a TV or audio equipment, and accordingly, video and audio can be outputted through the peripheral devices.

The input unit 185 is connected to the selection unit 170, and operates to deliver externally-input signals to the selection unit 170. Signal output terminals of the external devices such as camcorder, are connected to the input unit 185. Accordingly, the signals of the external devices can be transmitted to the combo system 100 via the input unit 185, and using the VCR unit 110, the externally-received signals can be recorded onto a magnetic tape or reproduced through a TV or monitor.

The combo system having a VCR unit and the DVDP unit has been described so far with reference to FIGS. 1 and 2. Recently, a combo system has been additionally provided with a settop box (STB) for receiving digital terrestrial television (DTT) broadcast signals. The settop box for receiving DTT signals will now be briefly called a ‘DTT unit’ for the sake of convenience. In the combo system having the VCR and DVDP units, each unit can communicate without interfering with the operation of the other unit. However, the combo systems having a VCR, a DVDP and DTT units frequently have a problem of interfering communications, and therefore, a new protocol for the smooth communication among the units, is required.

### SUMMARY OF THE INVENTION

Accordingly, the present invention has been made to solve at least the above-mentioned problems and to provide at least the advantages described herein. An aspect of the present invention is to provide a method for communicating among constituent devices of a video reproducing system.

It is another aspect of the present invention to provide a method for communicating among constituent devices of a video reproducing system using a connecting line as little as possible.

It is yet another aspect of the present invention to provide a method for varying the length of data transmission range in accordance with the amount of data being transmitted and received among the constituent devices of a video reproducing system.

The above aspects and/or other features of the present invention can be substantially achieved by providing an integrated system comprising at least three devices in a single housing, comprising a main control unit for controlling the operation of a first device of the three devices by performing an associated interface input/output of the integrated system, a first sub control unit for controlling the operation of a second device of the three devices by performing the processing of a signal transmitted from the main control unit, and a second sub control unit for controlling the operation of a third device of the three devices by performing the processing of a signal transmitted from the main control unit.

The above aspects and/or other features of the present invention can also be substantially achieved by providing a combined video reproducing apparatus system that has at least three components integrated therein, comprising a main component for comprehensively controlling the combo system, and at least two sub components which share a connecting line to the main component for communication.

### BRIEF DESCRIPTION OF THE DRAWINGS

The above aspects and features of embodiments of the present invention will be more apparent by describing certain embodiments of the present invention with reference to the accompanying drawings, in which:

FIG. 1 is a view illustrating the structure of a conventional VCR and DVDP combo system;

FIG. 2 is a view illustrating the structure of FIG. 1 in greater detail;

FIG. 3 is a view illustrating the structure of a combo system having a VCR unit, a DVDP unit and a DTT unit according to an embodiment of the present invention;

FIG. 4 is a view illustrating a communication protocol for communicating among the VCR unit, the DVDP unit and the DTT unit according to an embodiment of the present invention;

FIG. 5 is a view illustrating a communication protocol for communicating among the VCR unit, the DVDP unit and the DTT unit according to an embodiment of the present invention; and

FIG. 6 is a timing chart illustrating the communication process for the VCR unit, the DVDP unit and the DTT unit according to an embodiment of the present invention.

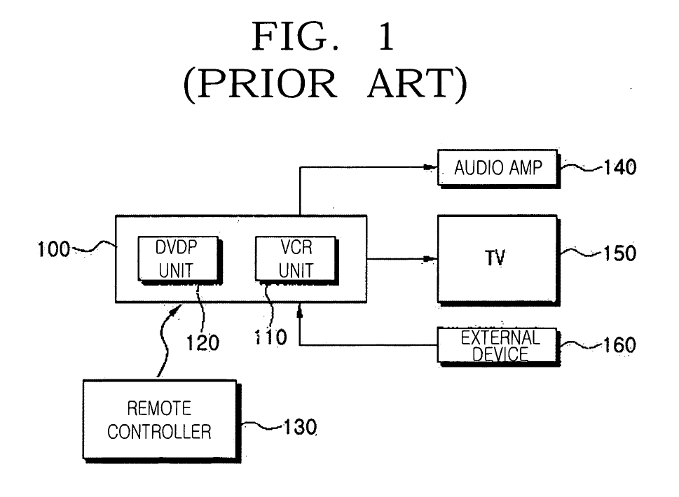

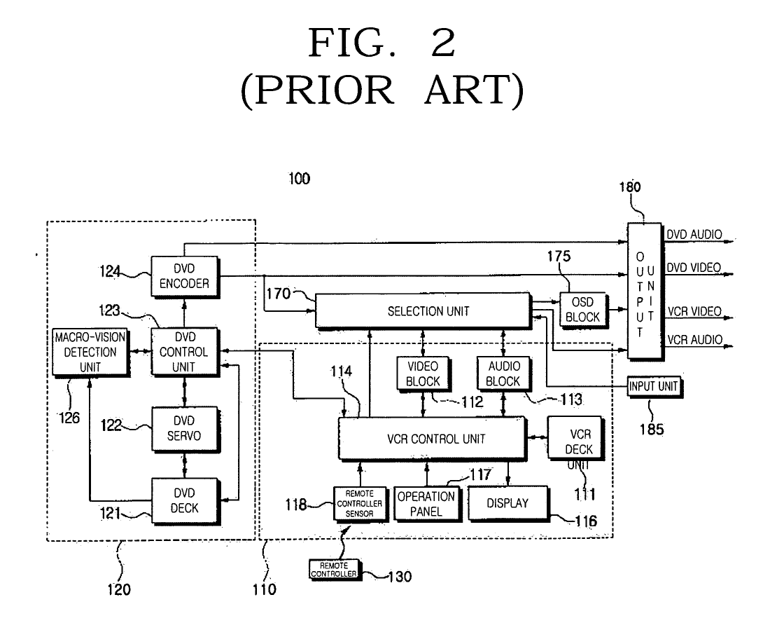

In the following description, it should be understood that the same drawing reference numerals are used for the same elements, features and structures throughout the drawings.

### DETAILED DESCRIPTION OF THE EXEMPLARY EMBODIMENTS

Certain embodiments of the present invention will be described in greater detail with reference to the accompanying drawings.

The matters defined in the description such as a detailed construction and elements are provided to assist in a comprehensive understanding of the invention. Thus, it is apparent that the present invention can be carried out with various changes and modifications to the exemplary embodiments described herein. Also, well-known functions or constructions, as described in the related art, will not be described in detail for the sake of clarity.

A DTT unit connects home appliances, such as TV, to cable or satellite broadcast sources. The DTT unit operates to amplify or remove noise, so as to scan channels and transmit corresponding video signals through the home appliance, such as a TV.

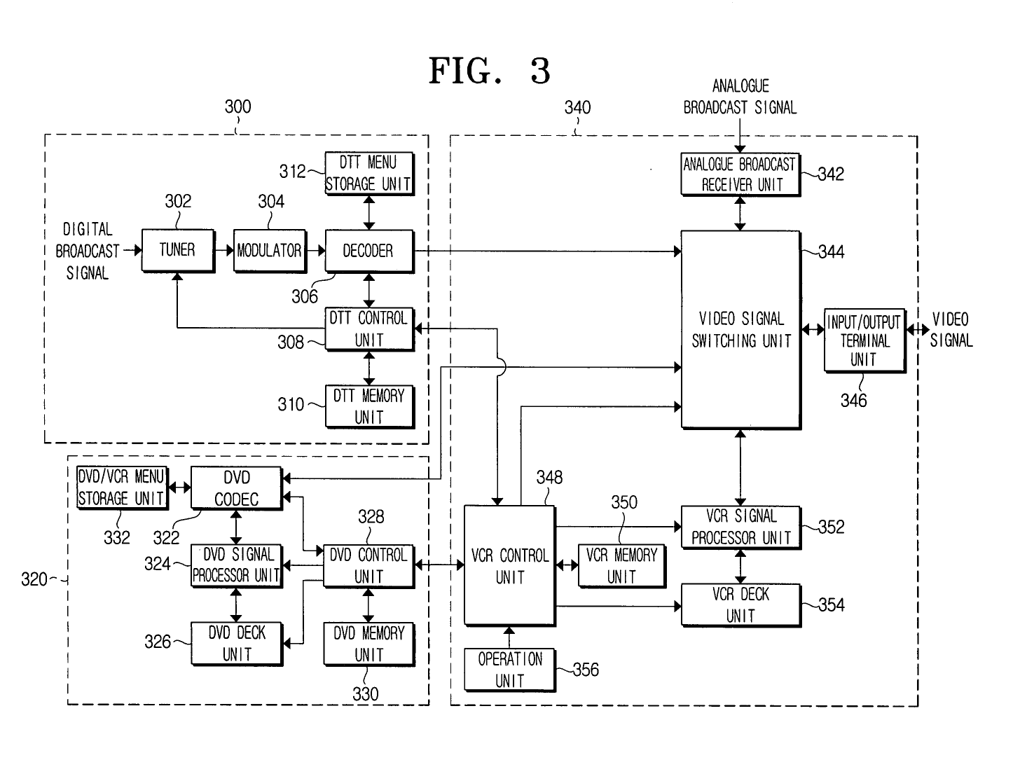

FIG. 3 is a block diagram of a combo system according to an embodiment of the present invention. More specifically, FIG. 3 shows a combo system having a VCR unit, a DVDP unit and a DDT unit. However, use of the DTT is only exemplary and other types of apparatus may be equally employed in a combo system as long as the apparatus receives video signals from at least two video sources for reproducing video and audio data.

Referring to FIG. 3, the combo system comprises a digital terrestrial television (DTT) unit 300, a digital video disc player (DVDP) unit 320, and a video cassette recorder (VCR) unit 340.

The DTT unit 300 comprises a settop box which selects and demodulates externally-introduced digital broadcast signals. The DVDP unit 320 comprises a recording and reproducing apparatus which operates to record video data to an optical recording medium such as a compact disc (CD) or a DVD, and reproduces video data from the recording medium.

The VCR unit 340 comprises a recording and reproducing apparatus which operates to record video data onto a magnetic recording medium such as a VCR tape, and reproduces the video data from the recording medium. The VCR unit 340 may additionally operate to select and modulate analogue broadcast signals which are introduced from outside.

The DTT unit 300, the DVDP unit 320 and the VCR unit 340 are integrated in a single casing. Accordingly, from the appearance, the combo system is a single integrated system, which connects to a user input device and an external device connecting terminal.

The DTT unit 300, the DVDP unit 320 and the VCR unit 340 of the combo system may be operated individually, or operated in association with each other. For example, a digital broadcast signal from the DTT unit 300 may be recorded onto the DVDP unit 320 or the VCR unit 340, or video data from the DVDP unit 320 may be recorded onto the VCR unit 340.

The combo system may be connected to external devices such as a TV or camcorder. In this case, the combo system may output received broadcast signals or reproduced video signals to the external devices. The combo system may also record video signals from the external devices.

Meanwhile, the combo system may not necessarily include each of the DTT unit 300, the DVDP unit 320 and the VCR unit 340. The DTT unit 300, the DVDP unit 320 and the VCR unit 340 may be constructed removably with respect to the combo system so that each can be selectively connected and disconnected with respect to the combo system.

For example, a user who already has a digital broadcast TV may not require the DTT unit 300, and accordingly, use a combo system without the DTT unit 300.

A combo system will now described that comprises a DTT unit 300, a DVDP unit 320 and a VCR unit 340. First, the DTT unit 300 will be described.

The DTT unit 300 includes a tuner 302, a modulator 304, a decoder 306, a DTT controller 308, a DTT memory unit 310 and a DTT menu storage unit 312.

The tuner 302 selects a channel requested by a user from among a plurality of digital broadcasting signals such as terrestrial, satellite, and cable signals.

The modulator 304 modulates the digital broadcast signal output from the tuner 302, and demultiplexes the modulated broadcast signals into a video signal, an audio signal and a broadcast information signal.

The decoder 306 decodes the demultiplexed video, audio and broadcast information signals. The video and audio signals output from the modulator 304 are in a predetermined compression format. Accordingly, the decoder 306 de-compresses the video and audio signals before outputting the same. The compression format is usually a moving picture experts group (MPEG) format.

The video and audio signals from the decoder 306 are converted by a DTT converting unit (not shown) into a format which is reproducible by the external devices, such as TV. The decoder 306 also decompresses graphic user interface (GUI) data which has been compressed and stored in a DTT menu storage unit 312.

The DTT control unit 308 controls the overall operation of the DTT unit 300. More specifically, the DTT control unit 308 controls the channel scanning of the tuner 302 and the operation of the decoder 306. The DTT control unit 308 is connected to a VCR control unit 348 for communication, and operates under the control of the VCR control unit 348.

The DTT memory unit 310 stores the driving programs and application programs required for the DTT control unit 308, and other important data which should be maintained even when the power is off. The DTT menu storage unit 312 stores the GUI data such as the menu screen for the construction of GUI environment. As the need arises, for example, when the data amount is too large, the GUI data may be compressed and stored in a predetermined compression format. The compression format may be MPEG, or the joint photographic expert group (JPEG) format.

The DVDP unit 320 will now be described in more detail. The DVDP unit 320 includes a DVD CODEC (Coder/DECoder) 322, a DVD signal processor unit 324, a DVD deck unit 326, a DVD memory unit 330 and a DVD/VCR menu storage unit 332.

The DVD deck unit 326 records or reads data from the CD or DVD loaded therein. The DVD signal processor unit 324 performs signal processing such as error correction with respect to the data to be recorded in the DVD deck unit 326, or the data reproduced from the DVD deck unit 326.

The DVD CODEC 322 compresses the received data into a predetermined compression format, and sends the data to the DVD signal processor unit 324. When the data to be reproduced is received from the DVD signal processor unit 324, the DVD CODEC 322 decompresses the received data and outputs the same. Preferably, the MPEG format may be used. The de-compressed data from the DVD CODEC 322 is converted, through the DVD converting unit (not shown), into a format reproducible by the external devices such as TV. The DVD CODEC 322 also decompresses the GUI data, which has been compressed and stored in the DVD/VCR menu storage unit 332, which will be described in more below, and outputs the same.

The DVD control unit 328 controls the overall operation of the DVD unit 320. More specifically, the DVD control unit 328 controls the compression and decompression of DVD CODEC 322, the signal processing of the DVD signal processor unit 324 and the recording and reproducing operations of the DVD deck unit 326. The DVD control unit 328 is connected to a VCR control unit 348 (which will be described below) for communication, and operated under the control of the VCR control unit 348.

The DVD memory unit 330 stores the driving programs and application programs required for the DVD control unit 328, and other important data which should be maintained even when the power is off.

The DVD/VCR menu storage unit 332 stores the GUI data, which is related to the DVDP unit 320 and the GUI data related to the VCR unit 340, both of which are stored together. As the need arises, the GUI data may be compressed and stored in a predetermined compression format, such as MPEG format, and a JPEG format.

The VCR unit 340 will now be described in greater detail. The VCR unit 340 includes an analogue broadcast receiver unit 342, a video signal switching unit 344, an input/output terminal unit 346, a VCR signal processor unit 352, a VCR deck unit 354, a VCR control unit 348, a VCR memory unit 350 and an operation unit 356.

The analogue broadcast receiver unit 342 selects a channel requested by a user among a plurality of externally-introduced analogue broadcast signals, and modulates and outputs the broadcast signal. The VCR deck unit 354 records or reads data from a magnetic tape.

The VCR signal processor unit 352 converts the data for recording in the VCR deck unit 354 into a format recordable with respect to the magnetic tape. The VCR signal processor unit 352 also converts the data to be reproduced that is received from the VCR deck unit 354 into a format reproducible by the external devices such as TV.

The video signal switching unit 344 selectively transmits video signals of the DTT unit 300, the DVDP unit 320, the analogue broadcast receiver unit 342 and the VCR signal processor unit 352 to the input/output terminal unit 346. The video signal switching unit 344 selectively transmits the externally-received video signals, which are transmitted through the input/output terminal unit 346, to the DVDP unit 320 and the VCR signal processor unit 352.

The video signal switching unit 344 may be a multiplexer integrated circuit (MUX IC) that performs a multiplexing function. The video signal switching unit 344 sets the transmission route for the video signals under the control of the VCR control unit 348.

The input/output terminal unit 346 transmits video signals of the video signal switching unit 344 to the external device, and transmits the video signals from the external device to the video signal switching unit 344.

The VCR control unit 348 controls the overall operation of the combo system according to the operational commands input by the user through the operation unit 356. The VCR control unit 348 is connected to the DTT control unit 308 and the DVD control unit 328 for communication purposes, and controls the respective control units 308 and 328. In other words, the VCR control unit 348 operates as a main controller of the combo system.

When the user-input operational command is related to the VCR unit 340 operation, the VCR control unit 348 controls the operation of the VCR unit 340. More specifically, the VCR control unit 348 controls the signal receiving operations of the analogue broadcast receiver unit 342, the switching operations of the video signal switching unit 344, the signal processing operations of the VCR signal processor unit 352, and the recording and reproducing operations of the VCR deck unit 354.

Meanwhile, when the operational command of the user is related to the operations of the DTT unit 300 or the DVDP unit 320, the VCR control unit 348 transmits the operational command to the DTT control unit 308 or the DVD control unit 328. Accordingly, the DTT control unit 308 or the DVD control unit 328 controls its respective operations.

The VCR memory unit 350 stores the driving programs and application programs required for the VCR control unit 348, and other important data which should be maintained even when the power is off. Additionally, the VCR memory unit 350 stores the programs related to the general functions or the complex functions of the combo system.

The operation unit 356 is a user interface device which receives operation commands related to the function selection and operation control of the combo system. The operation unit 356 is generally provided in the front of the combo system. The operation unit 356 may comprise a remote controller for inputting operational commands of the user, and a remote controller receiver unit for transmitting signals of the remote controller to the VCR control unit 348.

The combo system will now be described with a connecting structure for the communicating among the respective components of the combo system, and then a protocol for enabling communication without interference will be described.

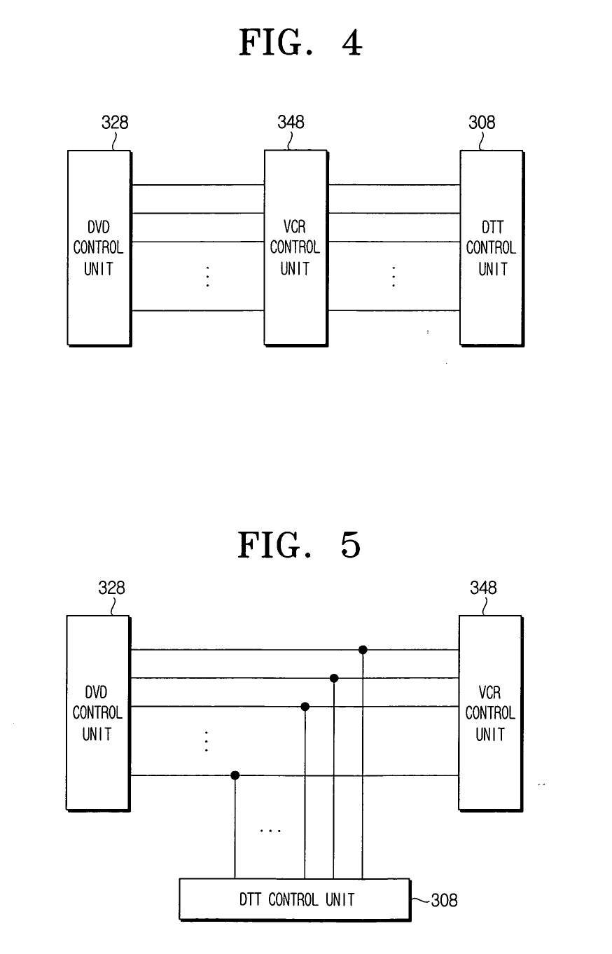

FIG. 4 shows a connecting structure of the VCR control unit 348, the DVD control unit 328 and the DTT control unit 308 according to an embodiment of the present invention.

To one side of the VCR control unit 348 is connected the DVD control unit 328, and to the other side, the DTT control unit 308 is connected. The number of lines connecting the VCR control unit 348 and the DVD control unit 328 can be selected by the user, or varied in accordance with the amount of data being transmitted and received. Also, the number of lines connecting the VCR control unit 348 and the DTT control unit 308 can also be varied. The number of lines connecting the VCR control unit 348 and the DVD control unit 328 can be selected by the user, and, the number of lines connecting the VCR control unit 348 and the DTT control unit 308, can be selected by the user to be equal, or different. In the present embodiment, the number of lines connecting the VCR control unit 348 and the DVD control unit 328, and the number of lines connecting the VCR control unit 348 and the DTT control unit 308, are equal, but one will understand that this should not be construed as limiting.

The control units of the respective devices of the combo system are connected by using pins. This means that the number of pins should be increased when the number of devices connected with the VCR control unit 348 increases. Therefore, a method for connecting a plurality of devices using a limited number of pins, is required.

FIG. 5 shows an alternative connecting structure among the VCR control unit 348, the DVD control unit 328 and the DTT control unit 308 of the combo system according to an embodiment of the present invention. The difference between FIG. 5 and FIG. 4 is that a line connecting the DVD control unit 328 and the VCR control unit 348 also connects the DTT control unit 308 to the VCR control unit 348. By doing as the above, new devices can be additionally connected with the existing connecting lines (pins). Although only one new device is depicted as being additionally connected in FIG. 5, one will understand that the connecting structure of FIG. 5 can connect more than two additional devices.

Of course, the newly-added device may require more lines than the combo system currently has. In this case, as many lines as required can simply be.

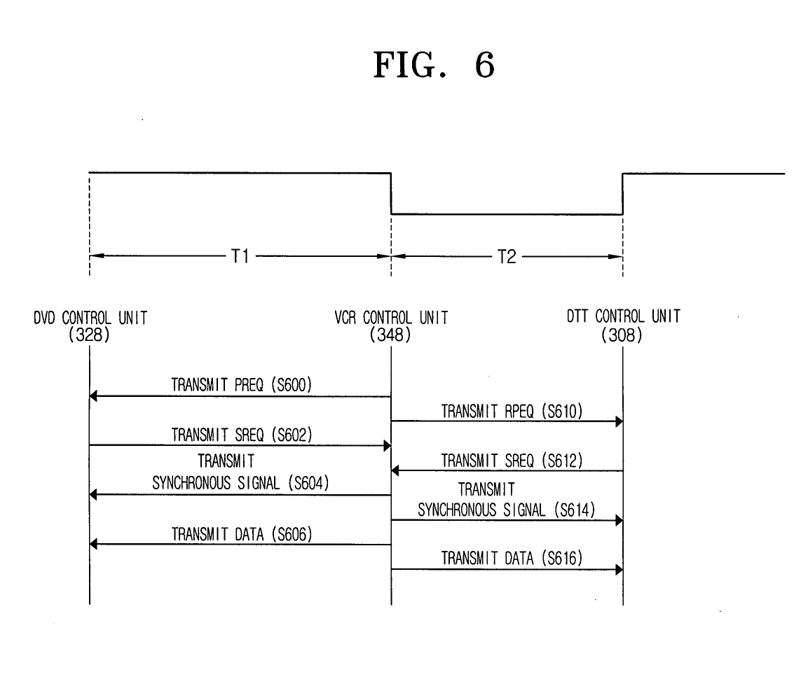

FIG. 6 shows a timing chart showing the interference-free communication among the components of the combo system. With reference to FIG. 6, the communication among the components of the combo system will now be described according to an embodiment of the present invention.

As shown in FIG. 6, there is an interval T1 for the communication between the VCR control unit 348 and the DVD control unit 328, and the T2 interval for the communication between the VCR control unit 348 and the DTT control unit 308. The length of the T1 and T2 intervals may vary as set by the user. For one instance, the T1 interval may be 60 ms (13 bytes) in length, while the T2 interval may be 40 ms (10 bytes) in length.

The T1 and the T2 intervals are divided from each other by using a clock signal. For example, the VCR control unit 348 and the DVD control unit 328 may communicate when there is a high clock signal, while the VCR control unit 348 and the DTT control unit 308 may communicate when there is low clock signal. The length of the clock signal may be set during the combo system manufacturing process, or adjusted by the user. Accordingly, when the amount of data being transmitted and received between the VCR control unit 348 and the DTT control unit 308 increases, the length of the T2 interval can be increased. To this end, the VCR control unit 348 of the combo system sets information about the clock signal therein, and accordingly, the VCR control unit 348 transmits the information about the clock signal to the DVD control unit 328 or the DTT control unit 308.

It will now be described about the communication process between the VCR control unit 348 and the DVD control unit 328 in the T1 interval. In the T1 interval, the VCR control unit 348 transmits a request message to the DVD control unit 328, requesting a communication (S600). The DVD control unit 328 transmits a response message to the requesting VCR control unit 348 (S602). The response message indicates that the communication is ready. Further, the VCR control unit 348 transmits a synchronous signal to synchronize with the DVD control unit 328 (S604). By transmitting and receiving the synchronization signal, the VCR control unit 348 and the DVD control unit 328 transmits and receives data without an error.

When the above processes are completed, the VCR control unit 348 transmits the data to the DVD control unit 328 (S606). With reference to FIG. 6, i the process in which the VCR control unit 348 request communication to the DVD control unit 328 was described. However, one will easily understand that the DVD control unit 328 can transmits a request message to the VCR control unit 348, and the VCR control unit 348 transmits a response message. In other words, according to the number of connecting lines between the VCR control unit 348 and the DVD control unit 328, the VCR control unit 348 can both transmit and receive data.

When the T1 interval is ended, the VCR control unit 348 stops communication with the DVD control unit 328, and starts communication with the DTT control unit 308. The VCR control unit 348 and the DTT control unit 308 communicate with each other in the same processes as described above in the communication between the VCR control unit 348 and the DVD control unit 328 as shown in steps S610 through S616.

As described above in a few exemplary embodiments of the present invention, a minimum number of pins are used to interconnect the components of a combo system. Once established, such established connecting line can be utilized to transfer data with respect to later-added equipment. Accordingly, when new equipment is added to a combo system, inefficiency or inability to communicate due to lack of pins can be prevented. Furthermore, because the length of data transmission region can be adjusted in accordance with the data rate, data transmission can be performed more efficiently.

The foregoing embodiment and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

1. An integrated system comprising at least three devices in a single housing, comprising:
a main control unit for controlling the operation of a first device of the three devices, and performing an associated interface input/output of the integrated system;
a first sub control unit for controlling the operation of a second device of the three devices, and performing processing of a signal transmitted from the main control unit; and
a second sub control unit for controlling the operation of a third device of the three devices, and performing processing of a signal transmitted from the main control unit.

2. The integrated system of claim 1, wherein the first and the second sub control units are connected to each other by a separate connecting line, respectively.

3. The integrated system of claim 1, wherein the main control unit and the first and the second sub control units are connected to each other by a single shared connecting line.

4. The integrated system of claim 3, wherein the main control unit uses a clock signal, and communicates with the first and the second sub control units in different intervals of the clock signal.

5. The integrated system of claim 4, wherein the sizes of the different intervals of the clock signal vary in accordance with the amount of data being transmitted and received between the main control unit and the first sub control unit, or the second sub control unit.

6. A method of controlling at least three devices in a single housing, comprising the steps of:
(a) controlling the operation of a first device of the three devices, performing an associated interface input/output of the integrated system by a main control unit;
(b) controlling the operation of a second device of the three devices, performing processing of a signal transmitted from the main control unit by a first sub control unit; and
(c) controlling the operation of a third device of the three devices, performing processing of a signal transmitted from the main control unit by a second sub control unit.

7. The method of claim 6, wherein the first and the second sub control units are connected to each other by a separate connecting line, respectively.

8. The method of claim 6, wherein the main control unit and the first and the second sub control units are connected to each other by a single shared connecting line.

9. The method of claim 8, further comprising the step of:
using a clock signal by the main control unit, and
communicating between the main control unit and the first and the second sub control units in different intervals of the clock signal.

10. The method of claim 9, wherein the sizes of the different intervals of the clock signal vary in accordance with the amount of data being transmitted and received between the main control unit and the first sub control unit, or the second sub control unit.
